(19) United States
(12) Patent Application Publication
(10) Pub. No.: US 2016/0117993 A1
(43) Pub. Date: Apr. 28, 2016

(54) IMAGE FORMATION IN A SEGMENTED DISPLAY

(71) Applicant: PIXTRONIX, INC., San Diego, CA (US)

(72) Inventors: Edward Buckley, Melrose, MA (US); Jignesh Gandhi, Burlington, MA (US)

(73) Assignee: PIXTRONIX, INC., San Diego, CA (US)

(21) Appl. No.: 14/521,176

(22) Filed: Oct. 22, 2014

(51) Int. Cl. G09G 3/34

(52) U.S. Cl. CPC G09G 3/342; G09G 3/3413; G09G 3/346; G09G 2320/0646; G09G 2320/0666; G09G 2320/029; G09G 2320/0285

(57) ABSTRACT

This disclosure provides systems, methods and apparatus, including computer programs encoded on computer storage media, for forming an image on a display in a display device including a plurality of backlight segments. Each backlight segment is capable of illuminating a respective illumination display segment of a plurality of illumination display segments. In one aspect, a controller associated with the display device is capable of decomposing an image frame into a plurality of frame segments to be displayed on the plurality of illumination display segments. The controller can determine a separate frame segment specific contributing color (FSSCC) for each frame segment based on content of the respective frame segment and a criterion limiting the color difference between a pair of FSSCCs based on the spatial proximity of the respective display regions. The controller can display the image frame according to the plurality of determined FSSCCs.

### TECHNICAL FIELD

This disclosure relates to the field of displays, and in particular, to image formation processes used by displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus including a plurality of backlight segments and a controller. Each backlight segment is capable of illuminating a respective display region of a plurality of display regions. The controller configured to receive image data associated with an image frame and decompose the image data into a plurality of frame segments. Each frame segment is to be displayed on a respective display region of the plurality of display regions. The controller can determine a separate frame segment specific contributing color (FSSCC) for each frame segment based on content of the respective frame segment and a criterion limiting the color difference between a pair of FSSCCs based on the spatial proximity of the respective display regions. The controller can then display the image frame according to the determined FSSCCs.

In some implementations, the controller can determine the FSSCC by calculating for each frame segment one or more parameters indicative of content of the frame segment, identifying a FSSCC for each frame segment based on the respective one or more parameters and adjusting the identified FSSCCs based on color differences between pairs of the identified FSSCCs associated with corresponding frame segments. In adjusting the FSSCCs, the controller can compare color differences between pairs of identified FSSCCs to one or more thresholds and adjust at least one FSSCC associated with a color difference exceeding a threshold of the one or more thresholds. The controller can compute color differences based on the identified FSSCCs or perceived FSSCCs. The controller can derive the perceived FSSCCs from the identified FSSCCs using a Retinex-based relative reflectance model.

In some implementations, the controller can determine the FSSCC further based on a criterion limiting color difference between a pair of FSSCCs associated with temporally consecutive image frames for a single frame segment. The controller can enforce the color difference between the pair of FSSCCs associated with temporally consecutive image frames for a single frame segment to be smaller than a threshold. In some implementations, in determining the FSSCCs, the controller can calculate for each frame segment one or more parameters indicative of content of the frame segment and select an FSSCC for each frame segment based on the respective one or more parameters from a lookup table.

In some implementations, the controller can determine a dimming value for a light source of multiple light sources associated with a backlight segment of the plurality of backlight segments. The controller can determine a light source chromaticity associated with the determined light source dimming value based on a lookup table. The controller can map pixel values of the frame segment associated with the backlight segment to color values in a color gamut defined based on the determined light source chromaticity. The controller can then use the mapped pixel values to display the image data segment. In displaying the image frame, the controller can illuminate the light source according to the determined light source dimming value.

In some implementations, the apparatus includes a display including the plurality of display regions. Each of the plurality of display regions includes a plurality of display elements. The controller includes a processor capable of communicating with the display. The processor is capable of processing image data. The apparatus also includes a memory device capable of communicating with the processor. The apparatus can further include a driver circuit capable of sending at least one signal to the display. The controller is capable of sending at least a portion of the image data to the driver circuit. The apparatus can further include an image source module capable of sending the image data to the processor. The image source module includes at least one of a receiver, transceiver, and transmitter. The apparatus can further include an input device capable of receiving input data and communicating the input data to the processor.

Another innovative aspect of the subject matter described in this disclosure can be implemented in a computer readable medium including computer code instructions stored thereon. When executed by a controller, the executed computer code instructions cause the controller to receive image data associated with an image frame and decompose the image data into a plurality of frame segments. Each frame segment is to be displayed on a respective display region of a plurality of display regions. Each display region is illuminated by a separate backlight segment of a plurality of backlight segments. Based on content of the respective frame segment and a criterion limiting the color difference between a pair of FSSCCs based on the spatial proximity of the respective display regions, the executed computer code instructions can determine a separate frame segment specific contributing color (FSSCC) for each frame segment. The executed computer code instructions can then cause the controller to display the image frame according to the plurality of determined FSSCCs.

In some implementations, determining the FSSCC includes calculating for each frame segment one or more parameters indicative of content of the frame segment, identifying an FSSCC for each frame segment based on the respective one or more parameters and adjusting the identified FSSCCs based on color differences between pairs of the identified FSSCCs associated with corresponding frame segments. Adjusting the identified FSSCCs can include comparing color differences between pairs of identified FSSCCs to one or more thresholds and adjusting at least one FSSCC associated with a color difference exceeding a threshold of the one or more thresholds. The color differences can be computed based on the identified FSSCCs or perceived FSSCCs. The perceived FSSCCs can be derived from the identified FSSCCs using a Retinex-based relative reflectance model.

In some implementations, the executed computer code instructions determine a dimming value for a light source of multiple light sources associated with a backlight segment of the plurality of backlight segments. The executed computer code instructions can further determine a light source chromaticity associated with the determined light source dimming value based on a lookup table. The executed computer code instructions can further map pixel values of the frame segment associated with the backlight segment to color values in a color gamut defined based on the determined light source chromaticity. The executed computer code instructions can then cause the controller to use the mapped pixel values to display the image data segment. Displaying the image frame includes illuminating the light source according to the determined light source dimming value.

Another innovative aspect of the subject matter described in this disclosure can be implemented in an apparatus including means for receiving image data associated with an image frame and means for decomposing the image data into a plurality of frame segments. Each frame segment is to be displayed on a respective display region of the plurality of display regions. Each display region is illuminated by a separate illumination means segment of a plurality of illumination means segments. The apparatus also includes means for determining a separate frame segment specific contributing color (FSSCC) for each frame segment based on content of the respective frame segment and a criterion limiting the color difference between a pair of FSSCCs based on the spatial proximity of the respective display regions. The apparatus also includes means for displaying the image frame according to the plurality of determined FSSCCs.

In some implementations, the means for determining the FSSCC include means for calculating for each frame segment one or more parameters indicative of content of the frame segment, means for identifying an FSSCC for each frame segment based on the respective one or more parameters and means for adjusting the identified FSSCCs based on color differences between pairs of the identified FSSCCs associated with corresponding frame segments. The means for adjusting the FSSCCs can include means for comparing color differences between pairs of identified FSSCCs to one or more thresholds and means for adjusting at least one FSSCC associated with a color difference exceeding a threshold of the one or more thresholds. In some implementations, the apparatus can further include means for determining a dimming value for a light source of multiple light sources associated with an illumination means segment of the plurality of illumination means segments.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3 shows a block diagram of an example display apparatus incorporating a segmented backlight.

FIG. 4 shows a block diagram of example control logic suitable for use in the display apparatus shown in FIG. 3.

FIG. 5 shows a flow diagram of an example process of displaying an image frame.

FIG. 6A shows a flow diagram of an example process of selecting a frame segment specific contributing color (FSSCC) for each frame segment of a plurality of frame segments.

FIG. 6B shows a flow diagram of a second example process of determining a FSSCC for each frame segment of a plurality of frame segments.

FIG. 7 shows an example CIE x-y diagram illustrating light source chromaticity shift due to light source dimming.

FIG. 8 shows a flow diagram of an example process of determining and employing a separate color gamut for each illumination display segment of a plurality of illumination display segments.

FIGS. 9A and 9B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

A display device can be implemented as a segmented display. To display an image frame, each display segment displays a respective frame segment of the image frame. A separate set of light sources, such as light emitting diodes (LEDs), can be used to illuminate each respective display segment. For instance, a segmented backlight can be employed with a segmented display such that each display segment is illuminated by a respective backlight segment.

In forming an image frame on the segmented display, a controller of a display device can segment a received image frame and analyze the content of each frame segment. Based on the analysis results, the controller can determine a frame segment specific contributing color (FSSCC) for each image segment. For each frame segment, the determined FSSCC is used together with frame independent contributing colors (FICCs) as subfield colors when deriving color subfields for that frame segment. The determined FSSCCs can vary from one image segment to another. In determining the FSSCCs on a frame segment by frame segment basis, the controller is capable of enforcing slow temporal variation of FSSCCs for a given frame segment across temporally consecutive image frames and slow spatial variation of FSSCCs across different frame segments of a single image frame. The slow temporal variation condition for the FSSCCs can be formulated using a threshold value to limit the color difference between FSSCCs associated with a single image segment in two temporally consecutive image frames. The slow spatial variation condition for the FSSCCs can be formulated using threshold value(s) to limit the color difference between FSSCCs associated with distinct image segments in a single image frame.

In some implementations, the controller can further apply local dimming on a frame segment by frame segment basis. When applying local dimming, the controller can be capable of determining dimming values for each frame segment. Such dimming can lead to changes in light source chromaticity. Therefore, in some implementations, the controller can apply color gamut mapping on a frame segment by frame segment basis to take advantage of the dimming-induced light source chromaticity changes.

In some implementations, the segmented display is implemented through separate physical backlight segments. In some other implementations, the segmented display is implemented through logical divisions of the backlight into logical backlight segments that share a common light output. The difference in the light output of the logical backlights segments relative to one another can be achieved through the differential illumination of light sources distributed around the periphery or across the back of the backlight.

Particular implementations of the subject matter described in this disclosure can be implemented to realize one or more of the following potential advantages. In general, the image formation apparatus and processes disclosed herein reduce power consumption and improve image quality by employing a segmented backlight. The use of a segmented backlight can provide a reduction in power consumption by facilitating local dimming and provides for improved image quality by allowing the formation of more saturated colors and by providing higher color contrast. Selecting a FSSCC for each frame segment can reduce color breakup (CBU) image artifacts. In addition, image artifacts associated with using a segmented backlight can be diminished through placing constraints on spatial and temporal FSSCC variation. By enforcing a slow temporal variation condition on FSSCCs associated with a given frame segment across consecutive image frames, CBU may be further reduced. Also, by enforcing a slow spatial variation condition on FSSCCs between frame segments of a single image frame, metamerism-type artifacts can be diminished. Furthermore, performing color gamut mapping on a frame segment by frame segment basis to account for light source chromaticity changes resulting from local dimming allows the use of wider color gamut than typically can be generated using a non-segmented display.

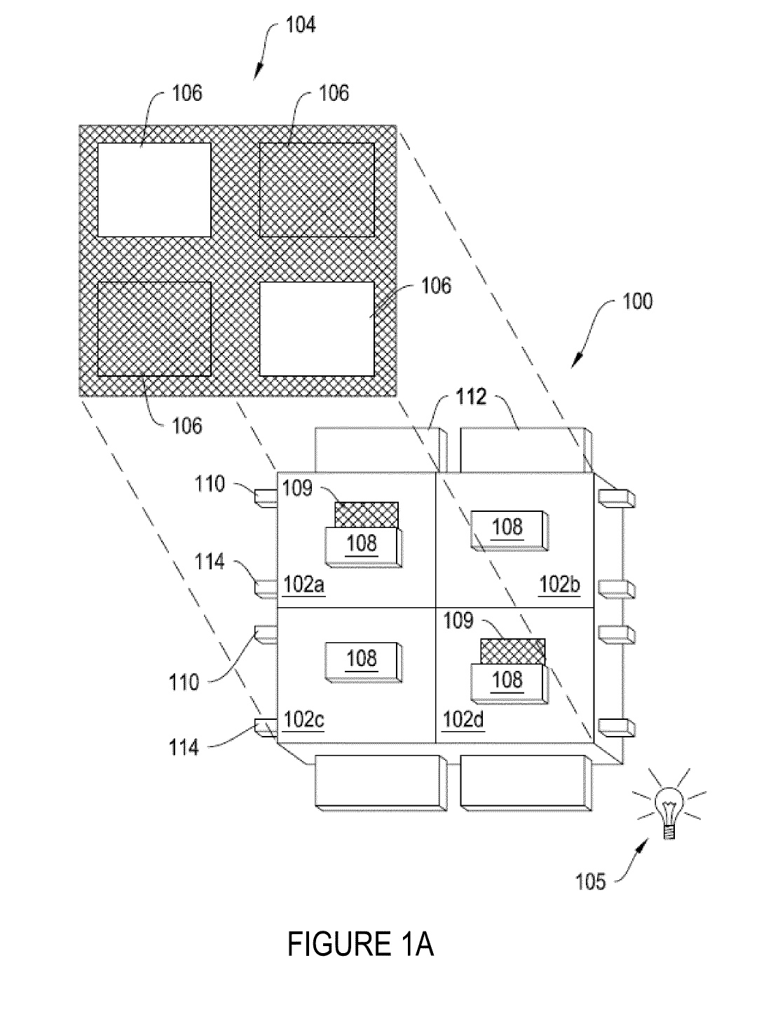

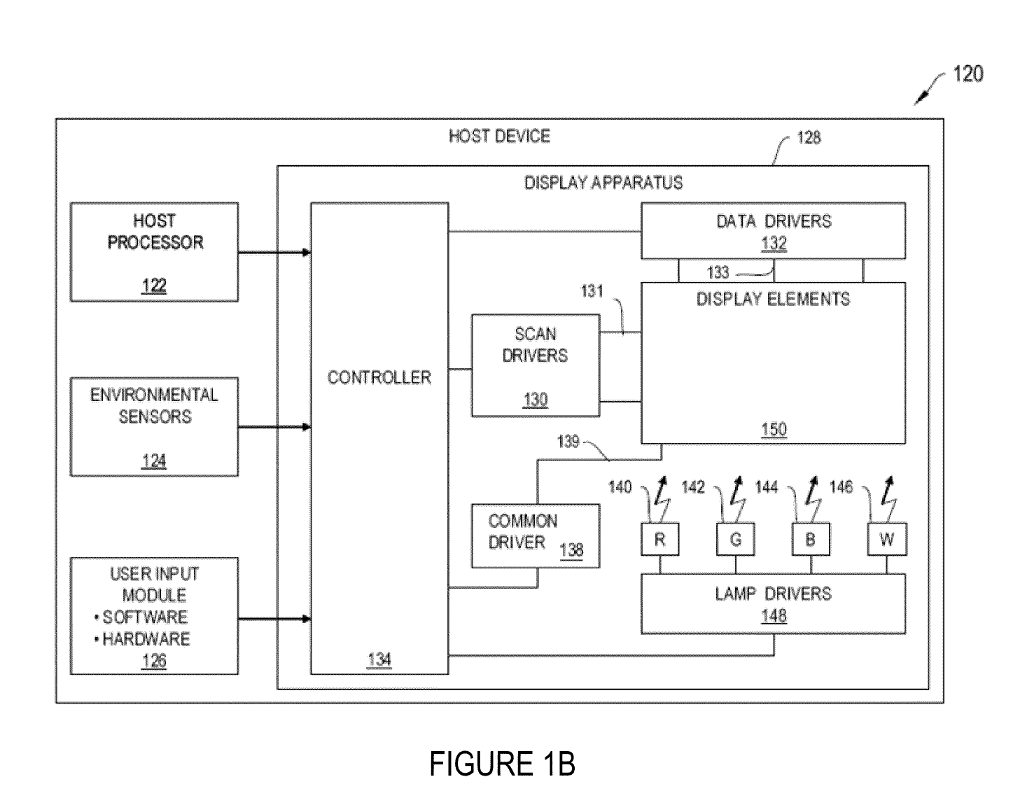

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiple rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

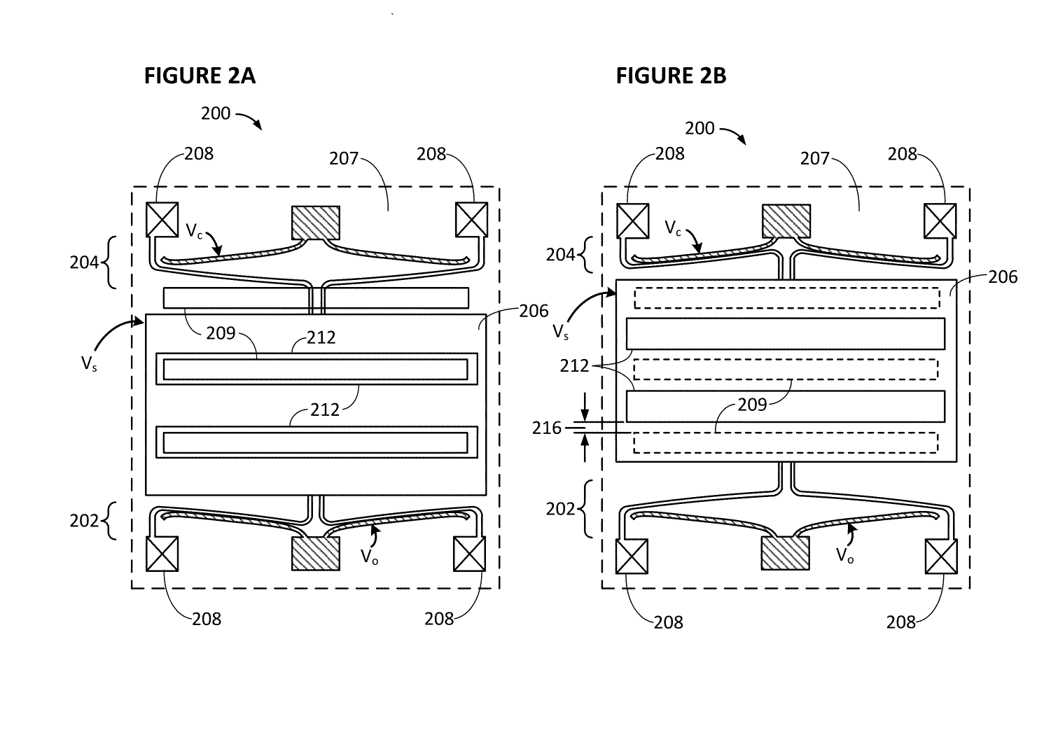

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

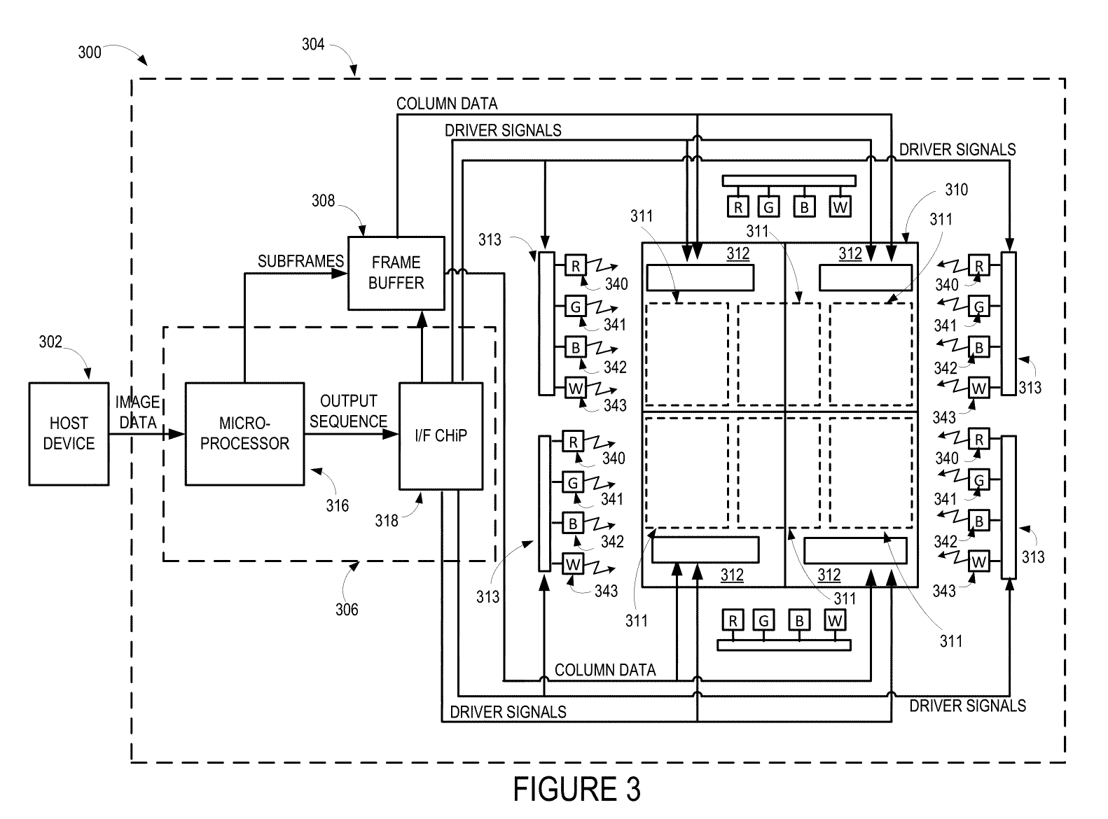

FIG. 3 shows a block diagram of an example display apparatus 300 incorporating a segmented display. The display apparatus 300 includes a host device 302 and a display module 304. The host device can be any of a number of electronic devices, such as a portable telephone, a smartphone, a watch, a tablet computer, a laptop computer, a desktop computer, a television, a set top box, a DVD or other media player, or any other device that provides graphical output to a display. In general, the host device 302 serves as a source for image data to be displayed on the display module 304.

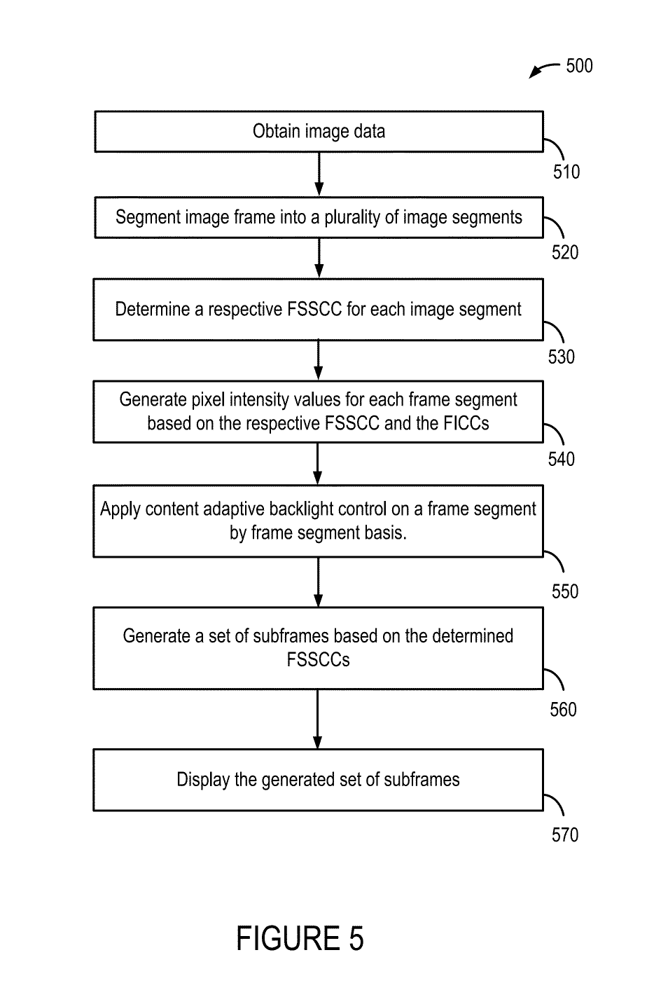

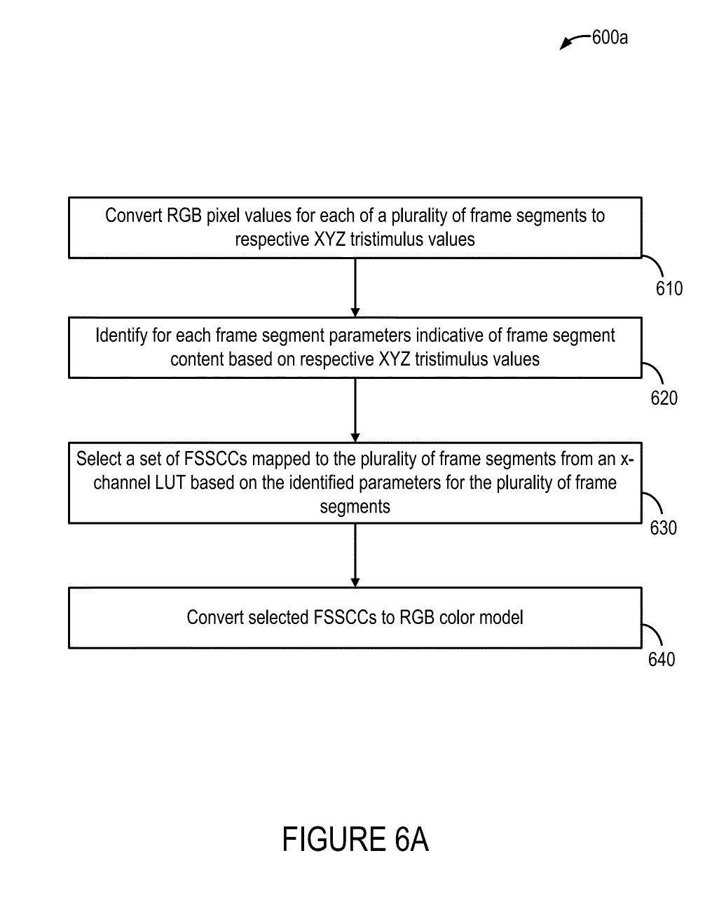

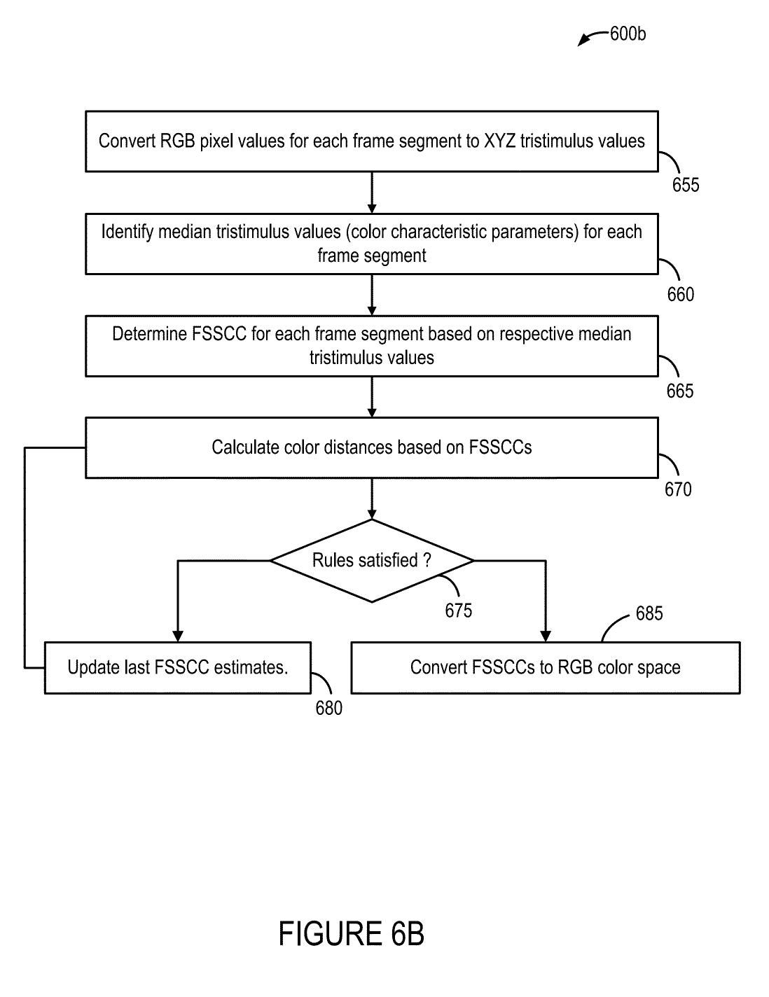

The display module 304 further includes control logic 306, a frame buffer 308, an array of display elements 310 arranged in four addressable display segments (also referred to as addressable display quadrants), display drivers 312, and a segmented backlight configured to differentially illuminate a set of illumination display segments 311. Each addressable display segment is addressed through a separate set of display drivers 312. In some implementations, the addressable display segments are not coincident with the illumination display segments 311. In some other implementations, each illumination display segment 311 corresponds to a respective addressable display segment. In general, the control logic 306 serves to process image data received from the host device 302 and controls the display drivers 312, array of display elements 310 and the backlight together to produce the images encoded in the image data. The functionality of the control logic 306 is described further below in relation to FIGS. 5, 6A and 6B.

In some implementations, as shown in FIG. 3, the functionality of the control logic 306 is divided between a microprocessor 316 and an interface (I/F) chip 318. In some implementations, the interface chip 318 is implemented in an integrated circuit logic device, such as an application specific integrated circuit (ASIC). In some implementations, the microprocessor 316 is configured to carry out all or substantially all of the image processing functionality of the control logic 306. In addition, the microprocessor 316 can be configured to determine an appropriate output sequence for the display module 304 to use to generate received images. For example, the microprocessor 316 can be configured to convert image frames included in the received image data into a set of image subframes. Each image subframe can be associated with a color and a weight, and includes desired states of each of the display elements in the array of display elements 310. The microprocessor 316 also can be configured to determine the number of image subframes to display to produce a given image frame, the order in which the image subframes are to be displayed, and parameters associated with implementing the appropriate weight for each of the image subframes. These parameters may include, in various implementations, the duration for which each of the respective image subframes is to be illuminated and the intensity of such illumination. These parameters (i.e., the number of subframes, the order and timing of their output, and their weight implementation parameters for each subframe) can be collectively referred to as an “output sequence.” In some implementations, the output sequence also can include data indicative of the voltage levels output by the display drivers 312 to actuate the display elements in the array of display elements 310.

The segmented backlight includes multiple lamps 340-343 and lamp drivers 313 and is configured to illuminate corresponding illumination display segments 311. In some implementations, the segmentation of the backlight is achieved through the use of separate physical components assigned to each segment. For example, each segment may include its own lamps 340-343, lamp drivers 313, and optically separated light guides. In some other implementations, the segmentation can be implemented through logical divisions of the backlight. The difference in the light output of the logical backlight segments relative to one another can be achieved through the differential illumination of light sources distributed around the periphery and across the back of the backlight. In some implementations, the logical divisions of the backlight do not provide perfect optical isolation between segments. For instance, the optical output of pixels located around or near an edge (or boundary) separating two neighboring illumination display segments 311 may be influenced by the light generated by neighboring illumination display segments 311. In such implementations, the pixel values for pixels at or near such boundaries can be adjusted according to a point-spread function determined for that display to account for this light “leakage” across the boundary of the illumination display segments 311.

In some implementations, each backlight segment can further include optical components (not shown in FIG. 3) for directing light from the light sources 340-343 to display elements in the respective illumination display segment 311 in a direct backlight configuration. In some other implementations, each backlight segment can include a light guide (not shown in FIG. 3) for distributing light emitted by the light sources 340-343 evenly beneath the display elements within its respective illumination display segment. In some implementations, the light sources 340-343 can include primary colors, such as red, green, blue, and white. The light source drivers 313 are configured to individually drive the light sources 340-343 to a plurality of discrete light levels to enable illumination gray scale and/or content adaptive backlight control (CABC) in the backlight segment. In some other implementations, for example in displays including reflective display elements, the display apparatus 300 can include front light segments or other form of lighting for each illumination display segment 311 instead of the backlight segments. The illumination of such alternative light sources can likewise be controlled according to illumination gray scale processes that incorporate content adaptive control features. For ease of explanation, the display processes discussed herein are described with respect to the use of a backlight segment for each illumination display segment 311. However, it would be readily understood by a person of ordinary skill that such processes also may be adapted for use with front light segments or other similar form of display lighting.

In some implementations, the control logic 306 is capable of segmenting the received image frame into a plurality of frame segments for displaying on respective illumination display segments 311. The control logic 306 is configured to determine a separate frame segment specific contributing color (FSSCC) for each frame segment. For each frame segment, the control logic 306 employs the determined FSSCC in conjunction with a set of frame independent contributing colors (FICCs) to derive color subfields for that frame segment. Based on the derived color subfields for the plurality of frame segments, the control logic 306 generates the subframes to be displayed and the output sequence to produce the received image frame. The output sequence can be generated in way to allow separate control of the backlight segments based on the determined FSSCC and the derived color subfields associated with the respective frame segment.

In some implementations, the control logic 306 is configured to determine the FSSCCs for the plurality of frame segments in a way that (1) FSSCCs for consecutive frame segments associated with a given illumination display segment 311 are prevented from rapidly varying from one image frame to the next and (2) the FSSCCs are prevented from rapidly varying across adjacent frame segments in a given image frame. The first condition imposes limits on temporal FSSCC variation across consecutive image frames. The second condition imposes limits on spatial variation of FSSCCs across adjacent frame segments of a given image frame. In some implementations, the allowed color difference of FSSCCs across a pair of any two frame segments in the same image frame depends on the spatial distance between the corresponding pair of illumination display segments 311. That is, for a given pair of frame segments to be displayed on a respective pair of illumination display segments, the color difference between their respective FSSCCs may be constrained based on the spatial distance between the respective illumination display segments 311. For instance, for a pair of illumination display segments 311 that are far apart (in terms of spatial distance), the control logic 306 can allow the color difference between their respective FSSCCs to be larger than the color difference the control logic 306 allows between FSSCCs of immediately adjacent illumination display segments 311.

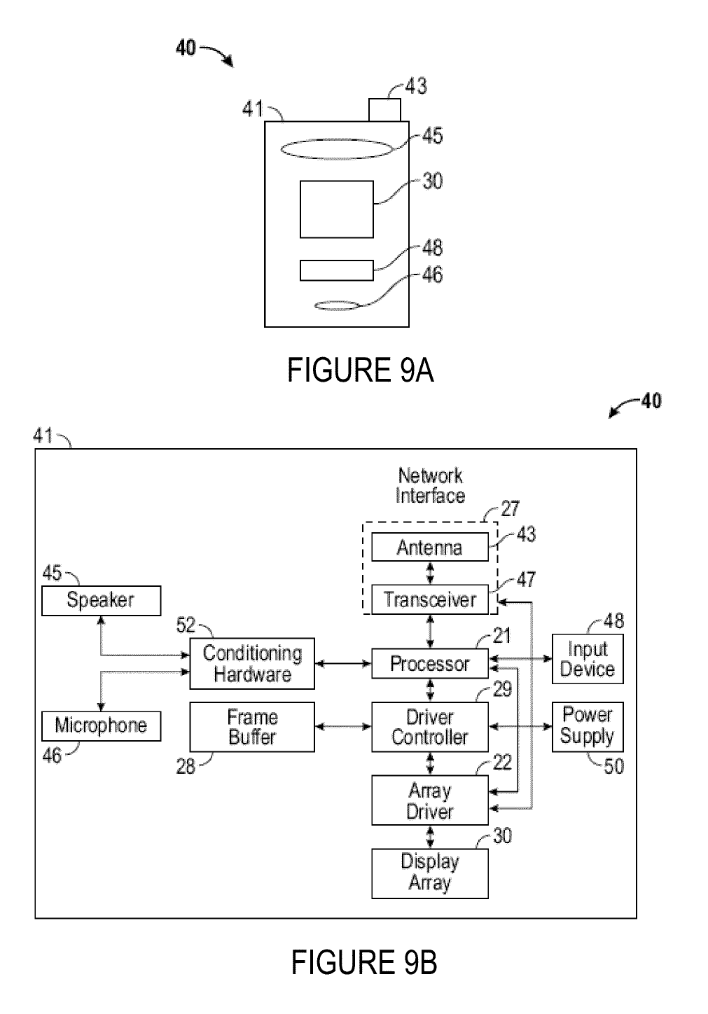

The interface chip 318 can be configured to carry out more routine operations of the display module 304. The operations may include retrieving image subframes from the frame buffer 308 and outputting control signals to the display drivers 312 and the backlight in response to the retrieved image subframes and the output sequence determined by the microprocessor 316. The frame buffer 308 can be any volatile or non-volatile integrated circuit memory, such as DRAM, high-speed cache memory, or flash memory (for example, the frame buffer 308 can be similar to the frame buffer 28 shown in FIG. 9B). In some other implementations, the interface chip 318 causes the frame buffer 308 to output data signals directly to the display drivers 312.

In some implementations, the functionality of the microprocessor 316 and the interface chip 318 are combined into a single logic device, which may take the form of a microprocessor, an ASIC, a field programmable gate array (FPGA) or other programmable logic device. For example, the functionality of the microprocessor 316 and the interface chip 318 can be implemented by a processor 21 shown in FIG. 9B. In some other implementations, the functionality of the microprocessor 316 and the interface chip 318 may be divided in other ways between multiple logic devices, including one or more microprocessors, ASICs, FPGAs, digital signal processors (DSPs) or other logic devices.

The array of display elements 310 can include an array of any type of display elements that can be used for image formation. In some implementations, the display elements can be EMS light modulators. In some such implementations, the display elements can be MEMS shutter-based light modulators similar to those shown in FIG. 2A or 2B. In some other implementations, the display elements can be other forms of light modulators, including liquid crystal light modulators, other types of EMS based light modulators, or light emitters, such as OLED emitters, configured for use with a time division gray scale image formation process.

The display drivers 312 can include a variety of drivers depending on the specific control matrix used to control the display elements in the array of display elements 310. In some implementations, the display drivers 312 include a plurality of scan drivers similar to the scan drivers 130, a plurality of data drivers similar to the data drivers 132, and a set of common drivers similar to the common drivers 138, all shown in FIG. 1B. As described above, the scan drivers output write enabling voltages to rows of display elements, while the data drivers output data signals along columns of display elements. The common drivers output signals to display elements in multiple rows and multiple columns of display elements.

As discussed above, the display module 304 can include multiple addressable display segments. In particular, the control matrix used to control the display elements in the array of display elements 310 is segmented into multiple addressable display segments. For example, the array of display elements 310 shown in FIG. 3 is segmented into four addressable quadrants. A person of ordinary skill in the art will readily appreciate that the array of display elements 310 can be segmented into another number of segments such as 6, 9, 12, 16, 20, or any other number of display segments. A separate set of display drivers 312 is coupled to each addressable display segment. Dividing a display into addressable display segments in this fashion reduces the propagation time needed for signals output by the display drivers 312 to reach the furthest display element coupled to a given driver, thereby decreasing the time needed to address the display. Segmenting the backlight into multiple backlight segments (each for illuminating a respective illumination display segment 311) can reduce the power requirements of the drivers 313 employed for instance by applying local dimming and FSSCC selection on frame segment by frame segment basis.

In some implementations, the display elements in the array of display elements can be utilized in a direct-view transmissive display. In direct-view transmissive displays, the display elements, such as EMS light modulators, selectively block light that originates from the backlight or a backlight segment, which is illuminated by one or more lamps 340-343. Such display elements can be fabricated on transparent substrates, made, for example, from glass. In some implementations, the display drivers 312 are coupled directly to the glass substrate on which the display elements are formed. In such implementations, the drivers are built using a chip-on-glass configuration. In some other implementations, the drivers are built on a separate circuit board and the outputs of the drivers are coupled to the substrate using, for example, flex cables or other wiring.

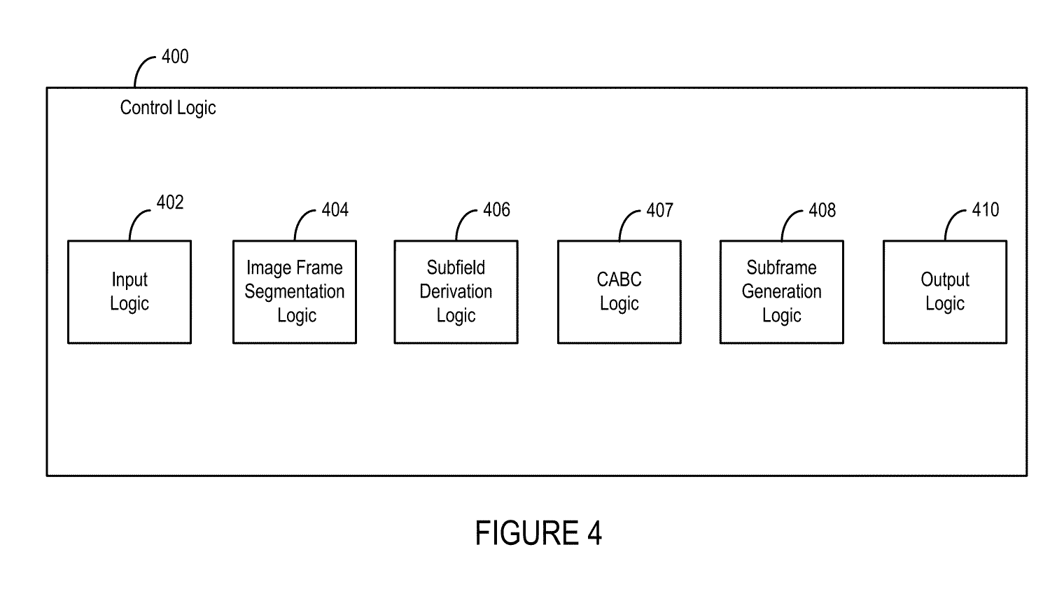

FIG. 4 shows a block diagram of example control logic 400 suitable for use as, for example, the control logic 306 in the display apparatus 300 shown in FIG. 3. More particularly, FIG. 4 shows a block diagram of functional modules executed by the microprocessor 316. Each functional module can be implemented as software in the form of computer executable instructions stored on a tangible computer readable medium, which can be executed by the microprocessor 316 or by an ASIC. The control logic 400 includes input logic 402, image frame segmentation logic 404, subfield derivation logic 406, subframe generation logic 408, and output logic 410. While shown as separate functional modules in FIG. 4, in some implementations, the functionality of two or more of the modules may be combined into one or more larger, more comprehensive modules.

The input logic 402 is capable of receiving the input image data as a stream of pixel intensity values, and present the pixel intensity values to other modules within the control logic 400. The image frame segmentation logic 404 is capable of segmenting the received image data into a plurality of frame segments. Each frame segment is to be displayed by a respective illumination display segment 311 (shown in FIG. 3). The subfield derivation logic 406 can derive color subfields (such as red, green, blue, white, etc.) for each frame segment based on the corresponding pixel intensity values. The subfield derivation logic 406 can be capable of determining a separate frame segment specific contributing color (FSSCC) for each frame segment based on the color content in the frame segment. The subfield derivation logic 406 can then derive the color subfields for each frame segment based on the determined FSSCC for the frame segment in conjunction with frame-independent contributing colors (FICCs). The subframe generation logic 408 can generate subframes for each of the color subfields based on the output sequence and the pixel intensity values. The output logic 410 can coordinate with one or more of the other logic components to determine an appropriate output sequence, and then use the output sequence to display the subframes on the display.

In some implementations, when executed by the microprocessor 316, the components of the control logic 400, along with the interface chip 318, display drivers 312, and backlight segments (all shown in FIG. 3), function to carry out a method for generating an image on a display, such as the processes 500, 600a and 600b shown in FIGS. 5, 6A and 6B, respectively. The functionality of the components of the control logic 400 is described further in relation to various operations carried out as part of the processes 500, 600a and 600b.

FIG. 5 shows a flow diagram of an example process 500 of displaying an image frame. In some implementations, the process 500 can be carried out by the control logic 400 (shown in FIG. 4). The process 500 includes obtaining an image frame (stage 510), segmenting the image frame into a plurality of image segments (stage 520), determining a FSSCC for each image segment (stage 530), generating pixel intensity values for each frame segment based on the respective FSSCC and the FICCs (stage 540), applying content adaptive backlight control on a frame segment by frame segment basis (stage 550), generating a set of subframes based on the determined FSSCCs (stage 560), and causing the subframes to be displayed (stage 570).

Referring to FIGS. 4 and 5, the process 500 includes obtaining an image frame (stage 510). The image frame can be obtained by the input logic 402. Typically, such image data is obtained by the input logic 402 as a stream of intensity values for the red, green, and blue components of each pixel in an image frame. The intensity values typically are received as binary numbers. The image data may be received directly from an image source, such as from an electronic storage medium incorporated into the display apparatus 128 (shown in FIG. 1B). Alternatively, it may be received from a host processor 122 incorporated into the host device 120 in which the display apparatus 128 is built (each of which are also shown in FIG. 1B).

The image frame segmentation logic 404 is capable of segmenting the obtained image frame into a plurality of frame segments (stage 520). Each frame segment is to be displayed in a respective illumination display segment 311 (shown in FIG. 3). Given n illumination display segments 311 of the display module 304 (both shown in FIG. 3) where n is an integer, the image frame is segmented into n respective frame segments. The boundaries of each frame segment can be defined based on the distribution of the array of display elements 310 among the plurality of illumination display segments 311 (both shown in FIG. 3). That is, each pixel in the image frame corresponds to a respective display element of the array of display elements 310. In some implementations, the image frame segmentation logic 404 preprocesses the obtained image frame. For example, in some implementations, the image data includes color intensity values for more pixels or fewer pixels than are included in the display apparatus 128 (shown in FIG. 1B). In such implementations, the input logic 402, the image frame segmentation logic 404, or other logic incorporated into the control logic 400 can scale the image data appropriately to the number of display elements in the array of display elements 310. In some other implementations, the image frame data is received having been encoded assuming a given display gamma. In some implementations, if such gamma encoding is detected, logic within the control logic 400 applies a gamma correction process to adjust the pixel intensity values to be more appropriate for the gamma of the display apparatus 128 (shown in FIG. 1B). For example, image data is often encoded based on the gamma of a typical liquid crystal (LCD) display. To address this common gamma encoding, the control logic 400 may store a gamma correction lookup table (LUT) from which it can quickly retrieve appropriate intensity values given a set of LCD gamma encoded pixel values. In some implementations, the LUT includes corresponding RGB intensity values having a 16 bit-per-color resolution, though other color resolutions may be used in other implementations.

In some implementations, the image frame preprocessing includes a dithering stage. In some implementations, the process of de-gamma encoding an image results in 16 bit-per-color pixel values, even though the display apparatus 128 may not be configured for displaying such a large number of bits per color. A dithering process can help distribute any quantization error associated with converting these pixel values down to a color resolution available to the display, such as 4, 5, 6, or 8 bits per color. In some implementations, the process of gamma correction and/or dithering can be performed by the subfield derivation logic 406.

The subfield derivation logic 406 is capable of determining a separate frame segment specific contributing color (FSSCC) for each image segment (530). For each frame segment, the respective FSSCC together with frame independent contributing colors (FICCs) define the colors of the color subfields for the frame segment. In some implementations, the FICCs for each frame segment are selected independently of the content of the image segment or the image frame as a whole. In some implementations, the FICCs include component colors such as, without limitations, the colors red (R), green (G), or blue (B). The FSSCC for each frame segment can be a composite color that is formed from the combination of two or more other FICCs. The FSSCC can be white (W), yellow (Y), magenta (M), cyan (C), or any other composite color. In some implementations, the FSSCC for each frame segment can be determined based at least in part on the color content of the frame segment. In some implementations, the subfield derivation logic 406 is capable of selecting the FSSCC for each frame segment from a predetermined set of composite colors such as white, yellow, cyan, magenta, or any other composite color within the display's color gamut. In some other implementations, the FSSCC for a given image segment can be any composite color within the display's color gamut, and not necessarily restricted to a set of composite colors.

In some implementations, the subfield derivation logic 406 determines the FSSCC for each frame segment according to the following conditions of (1) slow temporal FSSCC variation for the frame segment across consecutive image frames, and (2) slow spatial FSSCC variation across frame segments in a single image frame. Limiting temporal variation of the FSSCC for each frame segment helps eliminate or diminish image artifacts such color breakup (CBU). Limiting spatial variation of FSSCCs across different image segments of a single image frame helps eliminate or alleviate metamerism-type artifacts.

For each of the n frame segments, the respective FSSCC in a given image frame is denoted as Cᵢ^{k}, where 1<i<n is the frame segment index and k is the image frame index. The FSSCC for each of the n frame segments in the previous image frame is denoted as Cᵢ^{k-1}. The terms Cᵢ^{k} and Cᵢ^{k-1} are vector values representing the color components of the FSSCC. For instance, if expressed in the XYZ tristimulus color space, Cᵢ^{k}=[xᵢ^{k}yᵢ^{k}zᵢ^{k}] where xᵢ^{k}, yᵢ^{k}, and zᵢ^{k} represent, respectively, the X, Y, and Z components of the FSSCC for the frame segment with index i in the image frame with index k. If expressed in the RGB color space, Cᵢ^{k}=[rᵢ^{k}gᵢ^{k}bᵢ^{k}] where rᵢ^{k}, gᵢ^{k}, and bᵢ^{k} represent, respectively, the R, G, and B components of the FSSCC for the frame segment with index i in the image frame with index k.

In some implementations, the slow temporal variation condition for an FSSCC of a given frame segment over consequent image frames can be formulated as |Cᵢ^{k}−Cᵢ^{k-1}|<T, where T is a threshold value. That is, the color difference between the FSSCCs of a single frame segment in two consecutive image frames is upper bounded by the threshold value T. In some implementations, the threshold value T can be fixed. In some other implementations, the threshold value T can vary based on the image frame, a location of the frame segment within the image frame, an application associated with the image frame, user preferences, a settings mode associated with the host device 302 (depicted in FIG. 3), or any other criterion. In some implementations, the slow temporal variation condition can be formulated using a separate threshold value for each color component such as |xᵢ^{k}−xᵢ^{k-1}|<Tₓ for the X component, |yᵢ^{k}−yᵢ^{k-1}|<T_{y} for the Y component, and |zᵢ^{k}−zᵢ^{k-1}|<T_{z} for the Z component where Tₓ, T_{y}, and T_{z} are threshold values.

In some implementations, the slow spatial variation condition can be formulated as |Cᵢ^{k}−Cⱼ^{k}|<Sᵢⱼ, where i and j represent indices of two distinct frame segments and the term Sᵢⱼ represents an upper bound threshold value for the color difference between the FSSCC of the frame segment with index i and the FSSCC of the frame segment with index j. In some implementations, the slow spatial variation condition is applied to adjacent image segments. That is, frame segments that are adjacent to each other have their respective FSSCCs constrained such that the color difference between the corresponding FSSCCs is less than a respective threshold value Sᵢⱼ In some other implementations, the spatial variation condition is applied to adjacent and non-adjacent frame segments. For a given pair of frame segments with indices i and j, respectively, the threshold values Sᵢⱼ can be dependent on a spatial distance Dᵢⱼ between the corresponding pair of illumination display segments 311.

In some implementations, the color difference between FSSCCs can be computed using control-logic-computed estimates of how the human visual system (HVS) would perceive the FSSCCs rather than using the actual FSSCC values determined by the control logic 400. For instance, estimates of perceived FSSCC values can be computed using a Retinex-theory based relative reflectance model. The relative reflectance, as set forth in the Retinex theory, represents the interpreted surface color of an object influenced by colors of surrounding objects. In some implementations, the relative reflectance R(i,j) of an illumination display segment i affected by another illumination display segment j can be computed as

$$R ( i , j ) = {\sum }_{l} δ log \frac{{I}_{l + 1}}{{I}_{l}}$$

$$δ log \frac{{I}_{l + 1}}{{I}_{l}} = \{ \begin{matrix}log \frac{{I}_{l + 1}}{{I}_{l}} , & if \vert log \frac{{I}_{l + 1}}{{I}_{l}} \vert > Threshold \\ 0 , & if \vert log \frac{{I}_{l + 1}}{{I}_{l}} \vert \leq Threshold\end{matrix}$$

where Iₗ denotes a color component (such as RGB color components) of the determined FSSCC value for the illumination display segment with index l, δ is a threshold operation and the sequence of illumination display segments with index l define a path from the illumination display segment i to the illumination display segment j.

In other words, given a set of initial FSSCCs Cᵢ^{k} associated with the illumination display segments, the subframe derivation logic 406 can compute the relative reflectance values for each color component of the FSSCCs of each illumination display segment and use the computed relative reflectance values to calculate the perceived FSSCC for the illumination display segment. The subframe derivation logic 406 can compute color differences between the perceived FSSCCs. The subframe derivation logic 406 can compare the computed color differences, as described above, to the corresponding thresholds Sᵢⱼ to determine whether or not to change the initial FSSCCs Cᵢ^{k}. A person of ordinary skill in the art will readily recognize that other relative reflectance models (other than the one described by the equation above) can be used to estimate the perceived FSSCCs. Such models may, or may not, be based on the Retinex theory.

Once the FSSCCs are determined for a given frame segment, the subfield derivation logic 406 can generate pixel intensity values for each color subfield (FICCs and FSSCC) for all pixels in the frame segment (stage 540). Most image data is received by the control logic 400 in the form of red (R), green (G), and blue (B) pixel values. For pixels within the frame segment, the subfield derivation logic 406 can be capable of adjusting the pixel intensity values for the R, G, and B subfield colors based on the determined FSSCC of the image segment. In some implementations, the subfield generation logic 406 can subtract the component color values of the FSSCC or a fraction thereof from the pixel intensity values of each pixel in the image segment. For example, if the determined FSSCC for the frame segment with index i has the component color values rᵢ^{k}=100, gᵢ^{k}=100 and bᵢ^{k}=50, and the pixel intensity values for a pixel within the same frame segment were: R=100, G=200, and B=155, the subfield generation logic 406 can subtract the FSSCC component color values from the pixel intensity values for each color. The adjusted pixel intensity values for the pixel would be R=0, G=100, and B=105, respectively. According to another example, if the pixel intensity values for a second pixel within the same image frame were: R=50, G=50, and B=50, the subfield generation logic 406 can subtract half of the FSSCC component color values from the pixel intensity values for each color. The adjusted pixel intensity values for the second pixel would be R=50−0.5×rᵢ^{k}=0, G=50−0.5×gᵢ^{k}=0, and B=50−0.5×bᵢ^{k}=25, respectively.

The content adaptive backlight control (CABC) logic 407 can apply content adaptive backlight control on a frame segment by frame segment basis (stage 550). In some implementations, the CABC logic 407 obtains the pixel intensity values generated for each frame segment by the subfield derivation logic 406 based on the respective FSSCC and the FICCs. The CABC logic 407 can analyze the color content of each frame segment and determine the light levels (or dimming values) for the light sources 340-343 associated with the display segment 311 to display the image segment. In some implementations, the dimming values for the colors R, G, B and W are determined in a way that the resulting dimming levels for the light sources 340-343 still allow the reconstruction of the image segment without loss. In some other implementations, the CABC logic 407 can determine the dimming values in a lossy way allowing color desaturation in one or more frame segments of the image frame. In some implementations, each light source in the display module (shown in FIG. 3) 304 is associated with the R, G or B color (no W light sources 343). In such implementations, dimming values are determined for the R, G and B light sources 340-342.

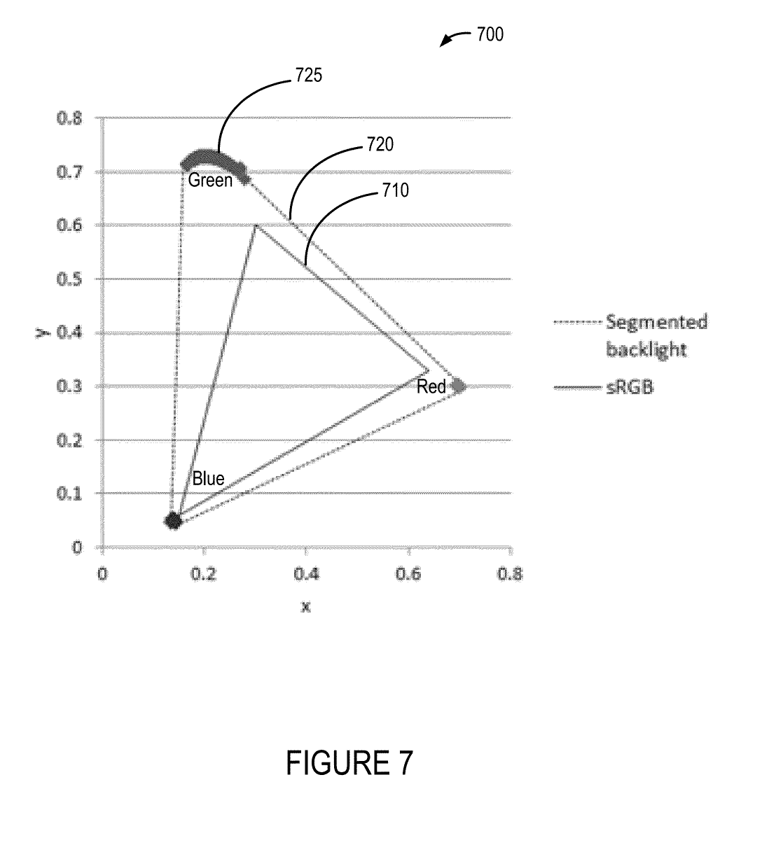

In applying content adaptive backlight control on a frame segment by frame segment basis, the CABC logic 407 can be further capable of identifying the chromaticities of the light sources 340-342 (shown in FIG. 3) corresponding to the determined dimming levels. In some implementations, the chromaticities of the lights sources 340-342 can be identified based on a light source calibration lookup table (LUT). The identified chromaticities can be used to adjust the pixel intensity values generated by the subfield derivation logic 406 based on the gamut associated with the light sources and the corresponding dimming levels. Dimming the light sources 340-342 is typically achieved by adjusting the driving electric currents applied to the light sources 340-342. However, the chromaticities of light sources such as RGB LEDs can be sensitive to the respective driving currents. That is, the chromaticity of a light source can exhibit a shift in response to the respective driving electric current. Such phenomenon is illustrated in FIG. 7.

FIG. 7 shows an example CIE x-y diagram 700 illustrating light source chromaticity shift due to light source dimming. The diagram 700 shows the standard RGB (sRGB) color gamut 710 and a color gamut 720 associated with light sources 340-342 illuminating a display segment 311. The highlighted portion 725 of the boundary of the color gamut 720 represents the shift in the chromaticity of the green light source 341 (shown in FIG. 3) due to a change in the respective driving electric current.

Referring back to FIGS. 4 and 5, the adjusting of the pixel intensity values (also referred to as gamut mapping) by the CABC logic 407 based on the identified light source chromaticities allows to account for any shifts in the chromaticities of light sources 340-342 due to local dimming at any frame segment. Also, as illustrated in FIG. 7, the color space covered by the color gamut 720 is substantially larger than that covered by the sRGB gamut 710. In some implementations, the color space covered by the color gamut 720 can be about 187% the color space covered by the sRGB color gamut 710 and about 146% the color space covered by the ADOBE RGB™ color gamut (not shown in FIG. 7).

The subframe generation logic 408 is capable of generating a set of subframes based on the determined FSSCC and the FICCs and the corresponding color subfields for each frame segment of the image frame (stage 560). Each bit-plane associated with one of the derived color subfields corresponds to a particular time slot in a time division gray scale image output sequence. It includes a desired state of each display element in the display for that time slot. In each time slot, a display element can take either a non-transmissive state or one or more states that allow for varying degrees of light transmission. In some implementations, the generated subframes include a distinct state value for each display element in the array of display elements 310 shown in FIG. 3.

In some implementations, the subframe generation logic 408 uses a code word lookup table (LUT) to generate the subframes. In some implementations the code word LUT stores series of binary values referred to as code words that indicate corresponding series of display element states that result in given pixel intensity values. In some implementations, multiple code word LUTs can be used. For instance, a separate code word LUT may be associated with each possible set of color subfields (FICCs and an FSSCC). Alternatively, each code word LUT can be associated with a respective color subfield component (either FICC or FSSCC). The value of each digit in the code word indicates a display element state (for example, light or dark) and the position of the digit in the code word represents the weight that is to be attributed to the state. In some implementations, the weights are assigned to each digit in the code word such that each digit is assigned a weight that is twice the weight of a preceding digit. In some other implementations, multiple digits of a code word may be assigned the same weight. In some other implementations, each digit is assigned a different weight, but the weights may not all increase according to a fixed pattern, digit to digit.

To generate a set of subframes, the subframe generation logic 408 obtains code words for all pixels in a color subfield. The subframe generation logic 408 can aggregate the digits in each of the respective positions in the code words for the set of pixels in the subfield together into subframes. For example, the digits in the first position of each code word for each pixel are aggregated into a first subframe. The digits in the second position of each code word for each pixel are aggregated into a second subframe, and so forth. The subframes, once generated, can be stored in the frame buffer 308 depicted in FIG. 3.

The output logic 410 is capable of causing the generated set of subframes to be displayed based on an output sequence (stage 570). In causing a given subframe to be displayed, the output logic 410 sends a separate set of instructions to the display elements 310 and the backlight associated with each display segment 311 (all shown in FIG. 3). The set of instructions for a given display segment 311 can include indications of states (such as ON or OFF) of the display elements 310 in the display segment 311, indications of states (such as ON or OFF) of the light sources 340-343 (shown in FIG. 3) of the display segment 311, and/or indications of light levels of the light sources 340-343 of the display segment 311. In some implementations, the output sequence can include the sets of instructions for the plurality of display segments 310 associated with different subframes. In some implementations, the output sequence also can include indications of the time instances at which the subframes are to be loaded into the display elements 312, the time instances at which the display elements 310 should be actuated to attain the states indicated in the subframes, the time instances at which the light sources 340-343 are to be illuminated for the subframes, the durations of the illuminations or the time instances the light sources 340-343 are to be extinguished for the subframes, and/or the magnitudes of the voltages to be output by the display drivers 312 to cause the display elements 310 in each display segment 311 to be appropriately actuated.

FIG. 6A shows a flow diagram of an example process 600a of selecting a FSSCC for each frame segment of a plurality of frame segments. The process 600a includes converting RGB pixel values associated with each image segment to XYZ tristimulus values (stage 610), identifying for each frame segment parameters indicative of frame segment content based on the respective XYZ tristimulus values (stage 620), selecting FSSCCs satisfying the temporal and spatial variation conditions for the plurality of frame segments based on the respective identified parameters and an FSSCC lookup table (stage 620), and converting the selected FSSCCs from the XYZ color model to the RGB color model (stage 620).

The subfield derivation logic 406 can obtain image data for each frame segment from the input logic 402 and/or the image frame segmentation logic 404. The image data is typically received in the form of red, green, and blue pixel values. Selection of the FSSCC for each frame segment can be more effective when evaluating a linear color space. The RGB color space is non-linear, but the XYZ color space is linear. In some implementations, the subfield derivation logic 406 processes the values of each pixel in a frame segment to convert them into the XYZ color space (stage 610). The conversion can be represented through the matrix multiplication

$$[ \begin{matrix}X \\ Y \\ Z\end{matrix} ] = M [ \begin{matrix}R \\ G \\ B\end{matrix} ]$$

where M is an XYZ transformation matrix defined as:

$$M = [ \begin{matrix}\frac{{x}_{r}^{gamut}}{{y}_{r}^{gamut}} {V}_{r} & \frac{{x}_{g}^{gamut}}{{y}_{g}^{gamut}} {V}_{g} & \frac{{x}_{b}^{gamut}}{{y}_{b}^{gamut}} {V}_{b} \\ {V}_{r} & {V}_{g} & {V}_{b} \\ \frac{\begin{matrix}1 - {x}_{r}^{gamut} - \\ {y}_{r}^{gamut}\end{matrix}}{{y}_{r}^{gamut}} {V}_{r} & \frac{1 - {x}_{g}^{gamut} - {y}_{g}^{gamut}}{{y}_{g}^{gamut}} {V}_{g} & \frac{1 - {x}_{b}^{gamut} - {y}_{b}^{gamut}}{{y}_{b}^{gamut}} {V}_{b}\end{matrix} ] .$$

The parameters xᵣ^{gamma}, yᵣ^{gamma}, x_{g}^{gamma}, y_{g}^{gamma}, x_{b}^{gamma}, and y_{b}^{gamma} correspond to the x and y coordinates of the red, green, and blue primaries, respectively, in the CIE color space whereas Vᵣ, V_{g}, and V_{b} correspond to the relative intensities of the red, green, and blue primaries in relation to the formation of the gamut's white point.

Upon converting the pixel values of the pixels in the image segment to the XYZ color space, the subfield derivation logic 406 can identify parameters indicative of the frame segment color content (stage 620). In some implementations, the identified parameters can be represented by the vector p=[pₓ p_{y} p_{z}], where pₓ, p_{y}, and p_{z} correspond, respectively, to the X, Y, and Z components. In some implementations, pₓ, p_{y}, and p_{z} represent the median values of the X, Y and Z components, respectively, for pixel values of all pixels in the frame segment. For instance, the subfield derivation logic 406 calculates pₓ as the median of X values for all pixels in the image segment. In some other implementations, the subfield derivation logic 406 calculates the median values using those pixels that have luminance values (i.e., values of Y) greater than a threshold luminance level, such as the mean Y value for the segment. In some other implementations, the subfield derivation logic 406 can calculate the parameters pₓ, p_{y}, and p_{z} as the mean values of the X, Y, and Z values, respectively, for all pixels in the frame segment. That is, pₓ=mean(X), p_{y}=mean(Y), and p_{z}=mean(Z), for X, Y, and Z values associated with pixels in the frame segment. A person of ordinary skill in the art will readily appreciate that the parameters pₓ, p_{y}, and p_{z} can be calculated in other ways such as based on other statistics of the pixel values in the X, Y and Z components, respectively, for all (or a subset of) the pixels in the frame segment.

Based on the identified parameters indicative of frame segment content for the plurality of frame segments, the subfield derivation logic 406 can select a set of FSSCCs matched to the plurality of frames segments from an FSSCC lookup table (LUT) (stage 630). The FSSCC LUT can include multiple matching combinations each of which maps a set, which in some implementations may be predetermined, of FSSCCs to the plurality of frame segments. In some implementations, for each of the parameters pₓ, p_{y}, and p_{z}, a set of interval ranges is defined. Each combination of interval ranges associated with the parameters pₓ, p_{y}, and p_{z} for the plurality of frame segments is mapped in the FSSCC LUT to a set of FSSCCs associated with the frame segments satisfying the slow temporal and spatial variation conditions. Given the identified parameters pₓ, p_{y}, and p_{z} for each of the plurality of frame segments, the subfield derivation logic 406 can determine the interval range, which in some implementations may be predetermined, corresponding to each of the identified parameters to obtain a combination of interval ranges. Based on the obtained combination of interval ranges, the subfield derivation logic 406 selects from the FSSCC LUT a set of FSSCCs associated with the plurality of frame segments.

In some implementations, the sets of FSSCCs associated with the plurality of frame segments in the FSSCC LUT can be pre-computed solutions to the problem described as

min_{c}_{ᵢ}_{^{k}}Σᵢ|Cᵢ^{k}−pᵢ|² subject to |Cᵢ^{k}−Cᵢ^{k-1}|<T and |Cᵢ^{k}−Cⱼ^{k}|<Sᵢⱼ for jεNᵢ,

where pᵢ represents a vector of identified parameters pₓ, p_{y}, and p_{z} for the frame segment with index i and Nᵢ represents a set of frame segments. The set Nᵢ can be the set of frame segments that are spatially adjacent to the frame segment with index i, a set including the plurality of frame segments except the frame segment with index i, or any other subset of the plurality of frame segments within the image frame having index k. In the formulation above, the entities Cᵢ^{k-1}, pᵢ, T, Sᵢⱼ, and Nᵢ are known.

Upon selecting the FSSCCs for the plurality of image segments, the subfield derivation logic 406 can convert the selected FSSCCs to the RGB color space (stage 640). For each frame segment, the respective FSSCC in the RGB space together with the FICCs can be used as the subfield colors for that frame segment and respective pixel intensity values for pixels in the frame segment can be computed accordingly. Alternatively, pixel intensity values can be computed using direct mapping from the XYZ color space using the XYZ coordinates of the FSSCCs and the FICCs.

FIG. 6B shows a flow diagram of a second example process 600b of determining a FSSCC for each frame segment of a plurality of frame segments. The process 600b includes converting RGB pixel values associated with each frame segment to XYZ tristimulus values (stage 655). For each frame segment, parameters indicative of frame segment content are identified based on the respective XYZ tristimulus values (stage 660). FSSCCs are determined based on the identified parameters (stage 665) and for each FSSCC color differences with other FSSCCs of frame segments in the previous and current image frame are calculated (stage 670). Based on the calculated color differences, the process 600b checks whether the FSSCCs satisfy the conditions of slow temporal and spatial variation (decision block 675). The process 600b updates the FSSCCs if the at least one of the conditions is not satisfied and loops back to stage 670 (stage 680), otherwise converts the FSSCCs from the XYZ color space to the RGB color space (stage 685).

The stages 655 and 660 of the process 600b are similar to the stages 610 and 620 of the process 600a. Upon identifying the parameters indicative of frame segment content, the subfield derivation logic 406 can determine an FSSCC for each frame segment based on the respective identified parameters. In some implementations, the color values such as the X, Y, and Z color tristimulus values of the FSSCC for a given frame segment are determined to be equal to the identified parameters pₓ, p_{y}, and p_{z} for that frame segment. In some other implementations, the component color values such as the X, Y, and Z of the FSSCC for a given frame segment can be determined based on (but not necessarily equal to) the identified parameters pₓ, p_{y}, and p_{z} for that frame segment. For instance, the X component of the FSSCC can be a scaled version (or shifted version) of the identified parameter pₓ.

For each determined FSSCC, the subfield derivation logic 406 can calculate color differences with other FSSCCs (stage 670). The subfield derivation logic 406 can calculate for each FSSCC associated with a frame segment a color difference (such as |Cᵢ^{k}−Cᵢ^{k-1}|) with the FSSCC associated with that frame segment in a previous image frame. The subfield derivation logic 406 also can compute the color differences |Cᵢ^{k}−Cⱼ^{k}| between FSSCCs associated with distinct frame segments in the current image frame. The color differences |Cᵢ^{k}−Cⱼ^{k}| can be calculated for all pairs of different frame segments or a subset thereof. For instances, such color differences can be calculated for pairs of spatially adjacent frame segments. In some implementations, the color differences can be Euclidian distances or any other distance metrics known to a person having ordinary skill in the art.

Based on the calculated color differences, the subfield derivation logic 406 can check whether the conditions of slow temporal and spatial variation are satisfied by the determined FSSCCs (decision block 675). In some implementations, the subfield derivation logic 406 compares the color differences |Cᵢ^{k}−Cᵢ^{k-1}| and |Cᵢ^{k}−Cᵢ^{k}| to the threshold values T and Sᵢⱼ, respectively, to determine if the temporal and spatial variation conditions are satisfied by the determined FSSCCs. If the temporal and spatial variation conditions are satisfied by the FSSCCs, the subfield derivation logic 406 converts the FSSCCs to the RGB color space (stage 685). For each frame segment, the respective FSSCC in the RGB color space can then be used with the FICCs as the subfield colors for that frame segment. As previously discussed in relation to FIG. 5, the subfield derivation logic 406 can compute pixel intensity values for all pixels in a given frame segment based on the respective FSSCC and the FICCs. Alternatively, direct conversion from the XYZ color space can be performed to compute the pixel intensity values for all pixels in a given frame segment based on the XYZ coordinates of the respective FSSCC and the FICCs.

If it is determined at the decision block 675 that the temporal and spatial variation conditions are not satisfied by the FSSCCs, the subfield derivation logic 406 updates the FSSCCs to decrease color differences found to exceed respective threshold values (stage 680). In some implementations, all FSSCC can be updated. In some other implementations, only a subset of the FSSCCs is updated. For instance, the subfield derivation logic 406 can update only FSSCC(s) associated with the largest calculated color differences. In some implementations, a given FSSCC can be updated according to a weighted sum such as Cᵢ^{k}←a₀Cᵢ^{k}+Cₖ⁻¹+c₀p+Σⱼbⱼ Cⱼ^{k}, where the variables a₀, a₁, c₀, and bⱼ represent weighting coefficients. Such weighting coefficients can be predetermined. Alternatively, the weighting coefficients (or a subset thereof) can be computed. For instance, the weighting coefficients can be computed based on the calculated color differences and or the threshold values. Updating the FSSCC(s) according to a weighted sum can reduce the color differences between the FSSCCs. In some implementations, upon updating the FSSCCs, the subfield derivation logic 406 can loop back to stage 670 and calculate the color differences |Cᵢ^{k}−Cᵢ^{k-1}| and |Cᵢ^{k}−Cⱼ^{k}| for the updated FSSCCs. In some other implementations, the FSSCCs can be updated at stage 680 in a way to enforce the temporal and spatial variation conditions in a single step. The process stages 665-685 can be viewed as a way to solve the problem formulated above as:

min_{c}_{ᵢ}_{^{k}}Σᵢ|Cᵢ^{k}−pᵢ|² subject to |Cᵢ^{k}−Cᵢ^{k-1}|<T and |Cᵢ^{k}−Cⱼ^{k}|<Sᵢⱼ for jεNᵢ,

A person having ordinary skill in the art should appreciate that the temporal and spatial variation conditions can be formulated differently than as described in the problem formulation above. A person having ordinary skill in the art should also appreciate that the problem formulation described above can be solved in many other ways using heuristic approaches, general theoretical solutions implemented using software or circuit logic, any other approach, or combinations thereof.

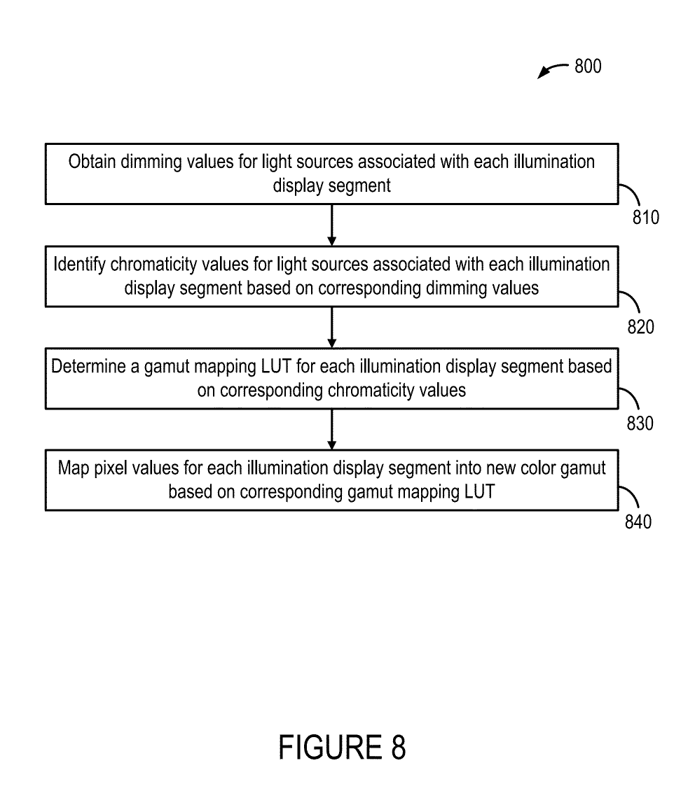

FIG. 8 shows a flow diagram of an example process 800 of determining and employing a separate color gamut for each illumination display segment of a plurality of illumination display segments. The process 800 includes obtaining dimming values of light sources for each illumination display segment (stage 810), identifying chromaticity values of light sources associated with each illumination display segment based on corresponding dimming values (stage 820), determining a gamut mapping lookup table (LUT) for each illumination display segment (stage 830) and mapping pixel values for each illumination display segment to respective new color gamut based on the corresponding determined gamut mapping LUT.

Referring back to FIGS. 3, 4 and 8, the process 800 includes obtaining dimming values of light sources for each illumination display segment (stage 810). In some implementations, the CABC logic 407 can analyze the color content of each frame segment and determine the light levels (or dimming values) for the light sources 340-343 (associated with the corresponding illumination display segment 311) to display the image segment. The CABC logic 407 can obtain the pixel intensity values generated for each frame segment by the subfield derivation logic 406 based on the respective FSSCC and the FICCs and use the maximum value for each of the FICCs and the FSSCC to determine the dimming value for each light source associated with the corresponding illumination display segment 311. For instance, the maximum pixel R value within the frame segment is used to determine the dimming value for the R light source 340, the maximum pixel G value within the frame segment is used to determine the dimming value for the G light source 341 and so forth.

The process 800 also includes identifying light sources chromaticity values for each illumination display segment based on corresponding dimming values (stage 820). As discussed above with respect to FIG. 7, dimming of light sources can result in shifts of the corresponding chromaticity values. The CABC logic 407 can identify the chromaticity values of the light sources 340-343 based on the corresponding dimming values and one or more light source calibration lookup table(s) (LUT(s)). The light source calibration LUT(s) can map dimming value ranges for the R, G, B and W light sources 340-343 to corresponding chromaticity values. In some implementations, a separate light source calibration LUT is associated with each of the R, G, B and W light sources 340-343. In some other implementations, a single light source calibration LUT is associated with the R, G, B and W light sources 340-343. The light source calibration LUT(s) can be obtained from a manufacturer of the light sources 340-343 or through experimental measurements.

The process 800 also includes determining a gamut mapping lookup table (LUT) for each illumination display segment (stage 830). Given the chromaticity values for the light sources 340-342 associated with a given illumination display segment 311, the CABC logic 407 can determine a gamut mapping LUT for use to adjust the pixel intensity values to be displayed on the illumination display segment 311. In some implementations, the CABC logic 407 can generate the gamut mapping LUT using a predefined gamut mapping LUT and a gamut varying function. For instance, the predefined gamut mapping LUT may correspond to specific predefined ranges of the light sources' chromaticity values. In such instances, the gamut varying function may be viewed as an interpolation function to interpolate gamut mapping for the light sources' chromaticity values outside the specific predefined values. In some other implementations, the CABC logic 407 can select a gamut mapping LUT from a plurality of pre-computed gamut mapping LUT based on the chromaticity values of the light sources 340-342.

The process 800 also includes mapping pixel values for each illumination display segment 311 to a respective new color gamut based on the determined gamut mapping LUT (stage 840). For each illumination display segment 311, the CABC logic 407 can update the corresponding pixel intensity values generated by the subfield derivation logic 406 based on the corresponding determined gamut mapping LUT. In other words, the chromaticity values identified in stage 820 for a given illumination display segment (or frame segment) represent the vertices (as shown in FIG. 7) of the color gamut to be used for that illumination display segment, and, at stage 840, the pixel intensity values are updated to be expressed in terms of the determined chromaticity values.

Performing color gamut mapping on a frame segment by frame segment basis allows the use of color gamuts that are wider than a single color gamut that is otherwise used for the whole image frame, and, therefore, results in improved image quality. For instance, as illustrated in FIG. 7, as the chromaticity value for the G light source 341 shifts closer towards the y-axis, the corresponding color gamut gets wider allowing for more colors to be represented.

FIGS. 9A and 9B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 9B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 9A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a plurality of backlight segments, each backlight segment being capable of illuminating a respective display region of a plurality of display regions; and
a controller configured to:
receive image data associated with an image frame;
decompose the image data into a plurality of frame segments, each frame segment to be displayed on a respective display region of the plurality of display regions;
determine a separate frame segment specific contributing color (FSSCC) for each frame segment based on:
content of the respective frame segment; and
a criterion limiting the color difference between a pair of FSSCCs based on the spatial proximity of the respective display regions; and
display the image frame according to the determined FSSCCs.

2. The apparatus of claim 1, wherein determining the FSSCC, the controller is further configured to:
calculate for each frame segment one or more parameters indicative of content of the frame segment;
identify a FSSCC for each frame segment based on the respective one or more parameters; and
adjust the identified FSSCCs based on color differences between pairs of the identified FSSCCs associated with corresponding frame segments.

3. The apparatus of claim 2, wherein adjusting the FSSCCs, the controller is further configured to:
compare color differences between pairs of identified FSSCCs to one or more thresholds; and
adjust at least one FSSCC associated with a color difference exceeding a threshold of the one or more thresholds.

4. The apparatus of claim 3, wherein the color differences are computed based on the identified FSSCCs or based on computed perceived values of the FSSCCs.

5. The apparatus of claim 4, wherein the computed perceived values of the FSSCCs are determined using a Retinex-based relative reflectance model.

6. The apparatus of claim 1, wherein determining the FSSCC is further based on a criterion limiting color difference between a pair of FSSCCs associated with temporally consecutive image frames for a single frame segment.

7. The apparatus of claim 6, wherein determining the FSSCC, the controller is further configured to enforce the color difference between the pair of FSSCCs associated with temporally consecutive image frames for a single frame segment to be smaller than a threshold.

8. The apparatus of claim 1, wherein determining the FSSCCs, the controller is further configured to:
calculate for each frame segment one or more parameters indicative of content of the frame segment; and
select an FSSCC for each frame segment based on the respective one or more parameters from a lookup table.

9. The apparatus of claim 1, wherein the controller is further configured to determine a dimming value for a light source of multiple light sources associated with a backlight segment of the plurality of backlight segments.

10. The apparatus of claim 9, wherein the controller is further configured to:
determine a light source chromaticity associated with the determined light source dimming value based on a lookup table;
map pixel values of the frame segment associated with the backlight segment to color values in a gamut defined based on the determined light source chromaticity; and
use the mapped pixel values to display the image data segment.

11. The apparatus of claim 10, wherein causing the image frame to be displayed includes causing the light source to be illuminated according to the determined light source dimming value.

12. The apparatus of claim 1, further comprising:
a display including the plurality of display regions, each of the plurality of display regions including a plurality of display elements, the controller including a processor capable of communicating with the display, the processor being capable of processing image data; and a memory device capable of communicating with the processor.

13. The apparatus of claim 12, further comprising:
a driver circuit capable of sending at least one signal to the display, the controller being capable of sending at least a portion of the image data to the driver circuit.

14. The apparatus of claim 12, further comprising:
an image source module capable of sending the image data to the processor, wherein the image source module includes at least one of a receiver, transceiver, and transmitter.

15. The apparatus of claim 12, further comprising:
an input device capable of receiving input data and communicating the input data to the processor.

16. A non-transitory computer readable medium with computer code instructions stored thereon, which when executed cause a processor to:
receive image data associated with an image frame;
decompose the image data into a plurality of frame segments, each frame segment to be displayed on a respective display region of a plurality of display regions, each display region illuminated by a separate backlight segment of a plurality of backlight segments;
determine a separate frame segment specific contributing color (FSSCC) for each frame segment based on content of the respective frame segment and a criterion limiting the color difference between a pair of FSSCCs based on the spatial proximity of the respective display regions; and
display the image frame according to the plurality of determined FSSCCs.

17. The non-transitory computer readable medium of claim 16, wherein determining the FSSCC includes:
calculating for each frame segment one or more parameters indicative of content of the frame segment;
identifying an FSSCC for each frame segment based on the respective one or more parameters; and
adjusting the identified FSSCCs based on color differences between pairs of the identified FSSCCs associated with corresponding frame segments.

18. The non-transitory computer readable medium of claim 17, wherein adjusting the FSSCCs includes:
comparing color differences between pairs of identified FSSCCs to one or more thresholds; and
adjusting at least one FSSCC associated with a color difference exceeding a threshold of the one or more thresholds.

19. The non-transitory computer readable medium of claim 18, wherein the color differences are determined based on the identified FSSCCs or based on computed perceived values of the FSSCCs.

20. The non-transitory computer readable medium of claim 19, wherein the computed perceived values of the FSSCCs are determined using a Retinex-based relative reflectance model.

21. The non-transitory computer readable medium of claim 16, wherein the computer code instructions when executed by the processor are further configured to:
determine a dimming value for a light source of multiple light sources associated with a backlight segment of the plurality of backlight segments.

22. The non-transitory computer readable medium of claim 21, wherein the computer code instructions when executed by the processor are further configured to:
determine a light source chromaticity associated with the determined light source dimming value based on a lookup table;
map pixel values of the frame segment associated with the backlight segment to color values in a gamut defined based on the determined light source chromaticity; and
display the image data segment using the mapped pixel values.

23. An apparatus comprising:
means for receiving image data associated with an image frame;
means for decomposing the image data into a plurality of frame segments, each frame segment to be displayed on a respective display region of the plurality of display regions, each display region illuminated by a separate illumination means segment of a plurality of illumination means segments;
means for determining a separate frame segment specific contributing color (FSSCC) for each frame segment based on content of the respective frame segment and a criterion limiting the color difference between a pair of FSSCCs based on the spatial proximity of the respective display regions; and
means for displaying the image frame according to the plurality of determined FSSCCs.

24. The apparatus of claim 23, wherein means for determining the FSSCC include:
means for calculating for each frame segment one or more parameters indicative of content of the frame segment;
means for identifying an FSSCC for each frame segment based on the respective one or more parameters; and
means for adjusting the identified FSSCCs based on color differences between pairs of the identified FSSCCs associated with corresponding frame segments.

25. The apparatus of claim 24, wherein the means for adjusting the FSSCCs include:
means for comparing color differences between pairs of identified FSSCCs to one or more thresholds; and
means for adjusting at least one FSSCC associated with a color difference exceeding a threshold of the one or more thresholds.

26. The apparatus of claim 25 further comprising:
means for determining a dimming value for a light source of multiple light sources associated with an illumination means segment of the plurality of illumination means segments.
